(19) United States
(12) Patent Application Publication
(10) Pub. No.: US 2015/0029112 A1
(43) Pub. Date: Jan. 29, 2015

(54) TOUCH SENSOR

(71) Applicant: NXP B.V., Eindhoven (NL)

(72) Inventor: Christophe Marc Macours, Leuven (BE)

(21) Appl. No.: 14/321,064

(22) Filed: Jul. 1, 2014

(30) Foreign Application Priority Data
Jul. 26, 2013 (EP) 13178189.0

(51) Int. Cl. G06F 3/041

(52) U.S. Cl. CPC G06F 3/0414
USPC 345/173

(57) ABSTRACT

A touch sensor (200) for a mobile device is disclosed which includes an acoustic port, and a loudspeaker operable to output audio through the acoustic port. The touch sensor is operable to generate a user input signal in response to the acoustic port being at least partially sealed. Partially sealing the acoustic port changes the acoustic load of the loudspeaker. The touch sensor may replace one or more hardware buttons on mobile devices such as mobile phones including smart phones. A method of operation of a touch sensor is also disclosed.

The invention relates to a touch sensor for a mobile device.

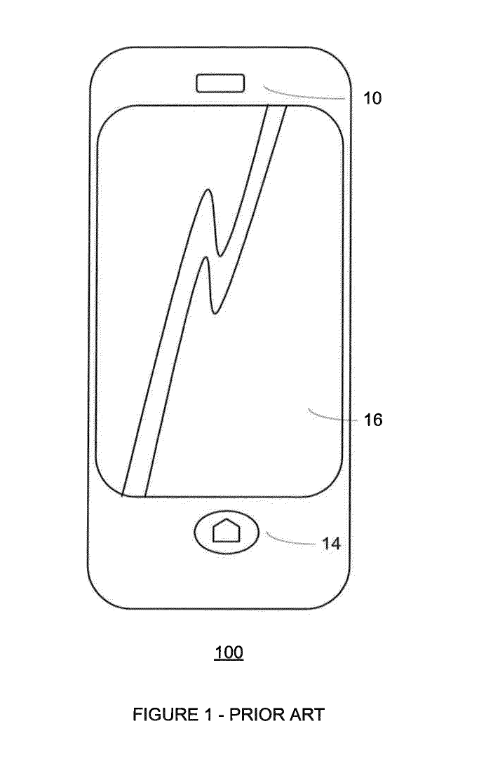

FIG. 1 shows a mobile phone 100 with a receiver speaker 10, a hardware button 14 and a touch sensitive display 16. Typically the display 16 is used for most user input functions with the hardware button 14 being used for example to wake up the device from standby mode when the display is switched off.

Various aspects of the invention are defined in the accompanying claims. In a first aspect there is described a touch sensor for a mobile device, the touch sensor comprising an acoustic port, a loudspeaker arranged to output audio through the acoustic port, and a detector coupled to the loudspeaker; wherein the detector is operable to detect a change in the acoustic load of the loudspeaker and wherein the touch sensor is operable to generate a user input signal in response to the acoustic port being at least partially sealed.

The touch sensor works on the principle that the loudspeaker acoustic load will be modified when the acoustic port or aperture is partially or fully closed or sealed. By detecting the change of acoustic load while the loudspeaker is being driven, a user input signal may be detected and interpreted as a user command to, for example, wake up a mobile device from a standby mode, go to a home screen or some other function The acoustic load may be changed, for example, by a user placing his or her finger over the acoustic port which may at least partially seal or close the acoustic port. The term acoustic load is known to the skilled person and may include for example a small cavity or volume in front of the loudspeaker, or a damping material.

Hardware buttons on mobile devices often require a large surface area to be operated correctly by the end-user. Because the touch sensor uses a loudspeaker which is also used for audio output, the hardware button may be removed giving a space saving on the device and reducing the cost.

In embodiments the detector may comprise a microphone acoustically coupled to the loudspeaker, and a detection circuit coupled to the microphone the microphone is operable to detect a change of sound pressure in response to the acoustic port being at least partially sealed, and to generate the user input signal in response to the detected sound pressure change.

The sound pressure change may be a result of changing the acoustic load which can be detected by a microphone.

In embodiments the detector is operable to detect a change in acoustic load by detecting a change in the loudspeaker electrical impedance. A change in acoustic load may cause a measureable change in the loudspeaker electrical impedance.

In embodiments a reference signal generator may be coupled to the loudspeaker.

The detection of a change in acoustic load requires the loudspeaker to be driven. In normal operation an audio signal will be output to drive the loudspeaker. However, as the normal audio output may not be continuous, in embodiments a reference signal can be generated for driving the loudspeaker when a normal audio signal is not present.

In embodiments including the reference signal generator, the reference signal generator may generate a non-audible signal. This is desirable to avoid unnecessary noise being generated. In embodiments, the non-audible signal may be a band-limited low frequency signal. The low frequency signal may be in the range of 1 Hz and the resonant frequency of the speaker. The resonant frequency of the loudspeaker may be in the range of 300 Hz to 600 Hz.

In embodiments the output of the reference signal generator may comprise a mixer having a first input coupled to an audio input, a second input coupled to the signal generator and an output coupled to the loudspeaker.

Mixing the reference signal with the regular audio signal allows a common signal path to an amplifier driving the speaker. If the reference signal is non-audible then the signal can be continuously generated without interfering with the audio quality.

In some embodiments of the touch sensor the detector may comprise a current sensor coupled to the loudspeaker input, and a controller coupled to the loudspeaker input and the output of the current sensor, wherein the controller comprises a voltage detector and is operable to generate a user input from a detected change in at least one of the voltage and current.

The detector may measure the voltage and current separately and combine them into an impedance value. The voltage detection may be the value at the input of the speaker or the input of an amplifier driving the speaker, particularly if the amplifier behaviour is linear.

In embodiments of the touch sensor the detector may comprise a comparator configured to compare a reference value with at least one instantaneous detected value and to output a user input signal determined by the comparison.

Since most of the time the acoustic port will be fully open so the loudspeaker can operate normally, the reference value corresponds to this status. The value may be an electrical impedance of the loudspeaker or a detected sound pressure level.

Embodiments may comprise a reference value detector having an input coupled to the loudspeaker and an output coupled to the first input of a comparator, an instantaneous impedance detector having an input coupled to the loudspeaker and an output coupled to a second comparator input wherein the reference value detector is operable to generate the reference value from a plurality of detected values detected over a reference time period and the instantaneous value detector is operable to generate the instantaneous value from at least one detected value detected over an instantaneous time period, wherein the reference time period is longer than the instantaneous time period.

The reference value may change over time due to for example a damaged speaker enclosure resulting in leakage from other apertures than the main acoustic port. By adapting the reference value based on a number of detected or sampled values over a time period, the reference value can be re-calibrated. The time period may be considered to be a refresh rate for the reference value. The instantaneous value may be a value calculated from one or more detected values over a much shorter time period than that used for reference value. The detected value may be derived for example from a microphone signal or an electrical impedance value of the loudspeaker.

Embodiments of the touch sensor may be incorporated into a mobile device which may be inter alia a mobile phone (including smart phone), a notebook, a laptop, a tablet computer, a personal digital organizer, a remote control and a portable music player.

A mobile phone or other mobile device may include more than one touch sensor as it may have multiple speakers so more than one hardware button may be replaced.

In a second aspect there is described a method for detecting a user input to a mobile device, the mobile device comprising an acoustic port, and a loudspeaker arranged to output audio through the acoustic port, the method comprising in response to the acoustic port being at least partially sealed, detecting a change in the acoustic load of the loudspeaker, and generating a user input signal.

Embodiments of the invention are now described in detail, by way of example only, illustrated by the accompanying drawings in which:

FIG. 1 shows a known mobile phone.

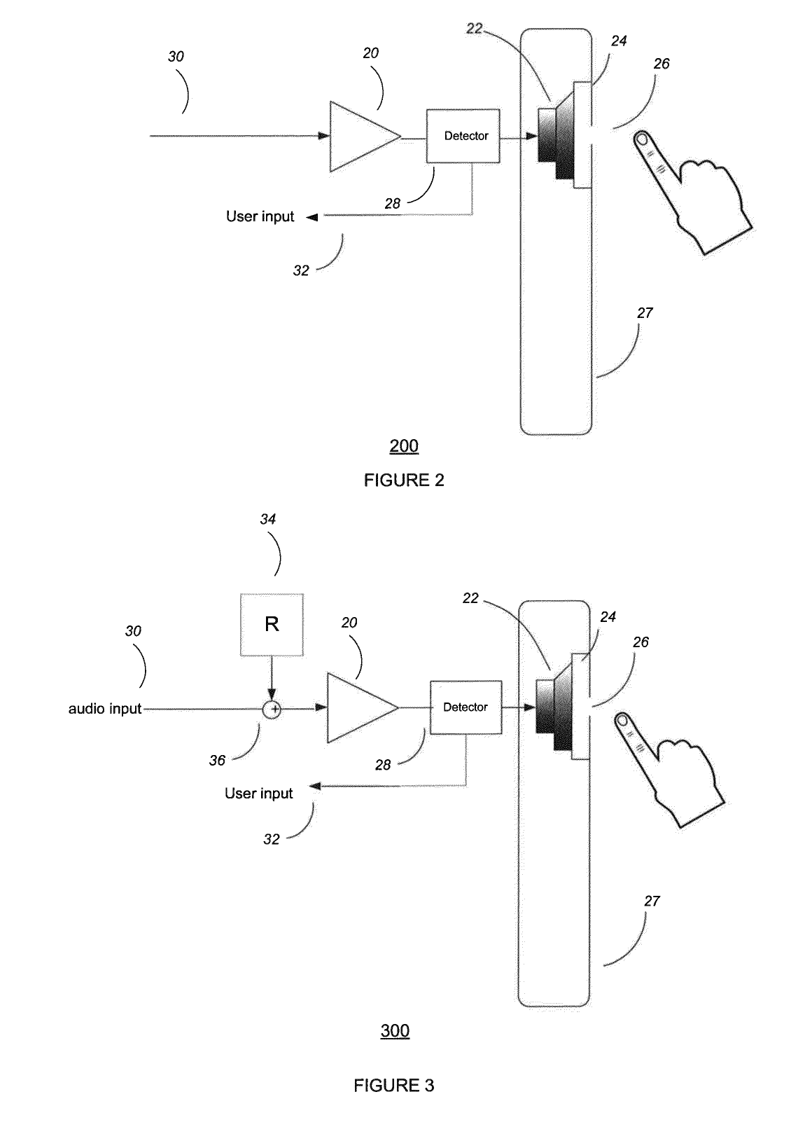

FIG. 2 illustrates a touch sensor according to an embodiment.

FIG. 3 shows a further touch sensor according to an embodiment.

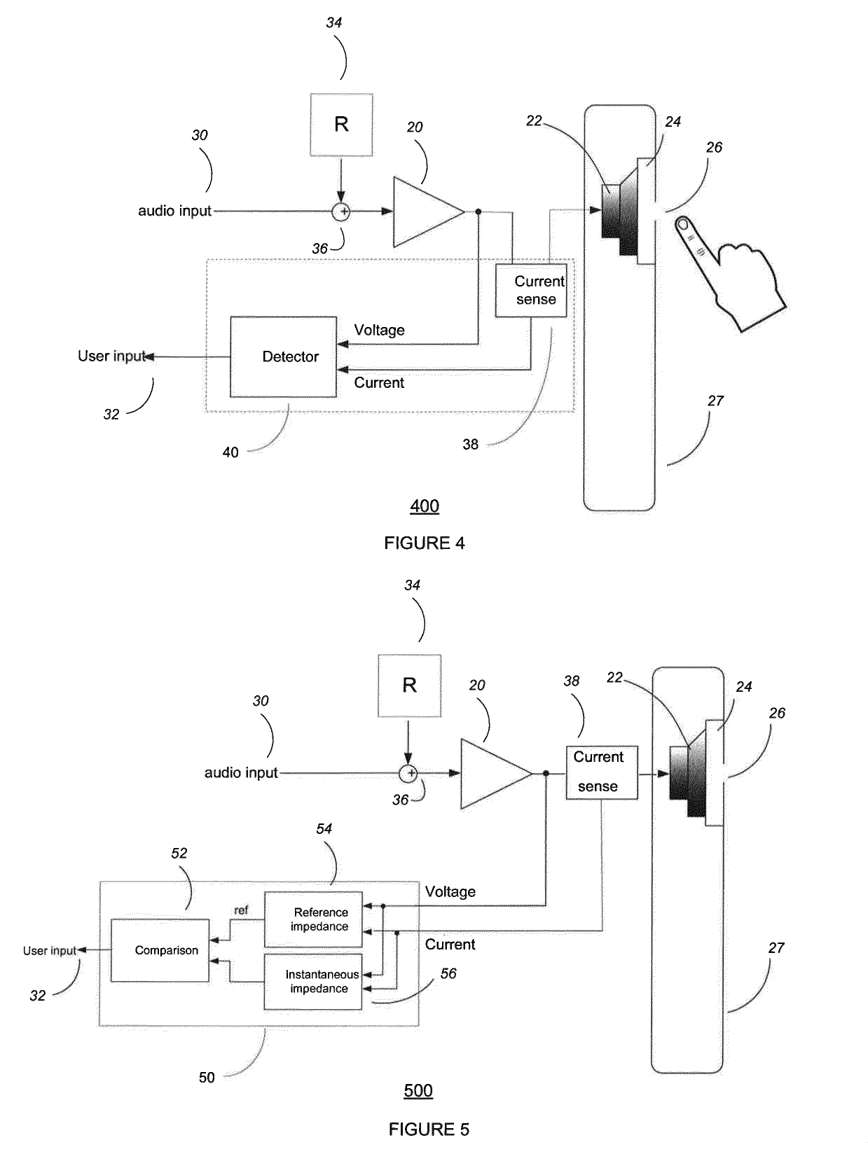

FIG. 4 illustrates a touch sensor according to an embodiment.

FIG. 5 shows a further touch sensor according to an embodiment.

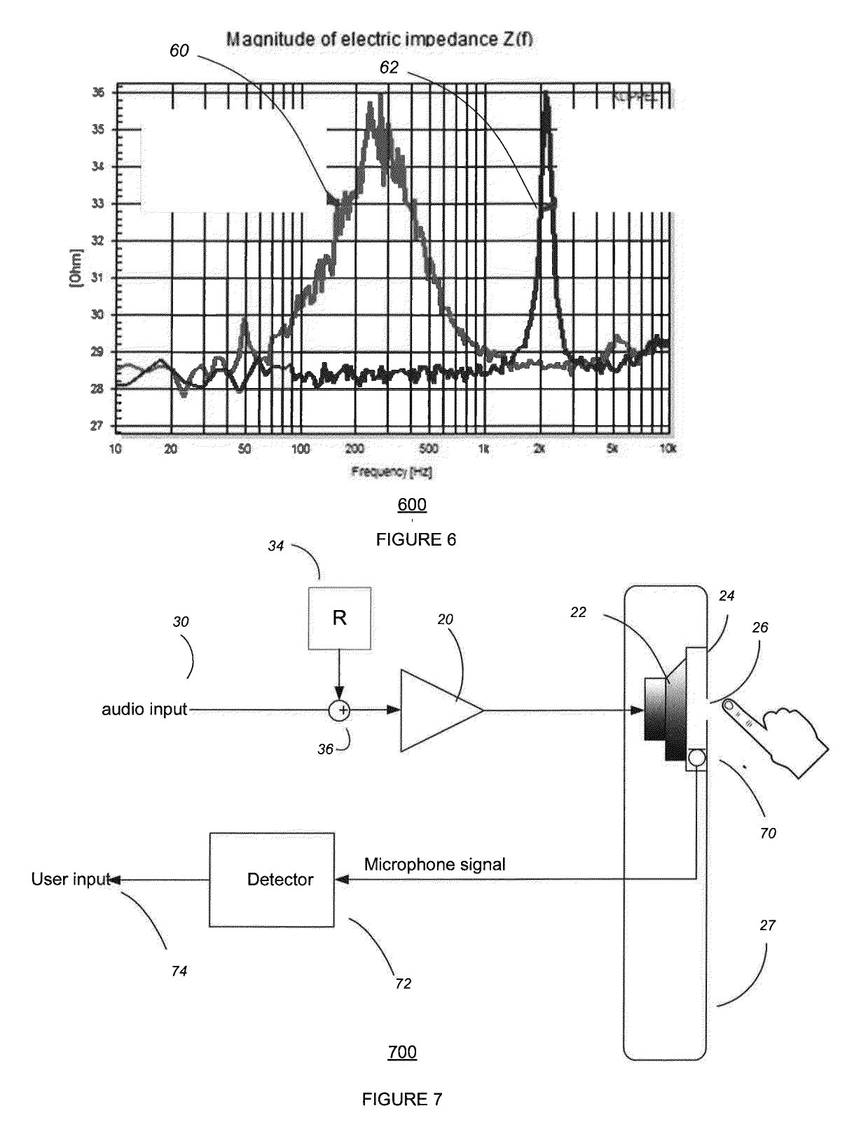

FIG. 6 illustrates the impedance change of a mobile phone loudspeaker when an embodiment of the touch sensor is being operated.

FIG. 7 shows a touch sensor according to an embodiment.

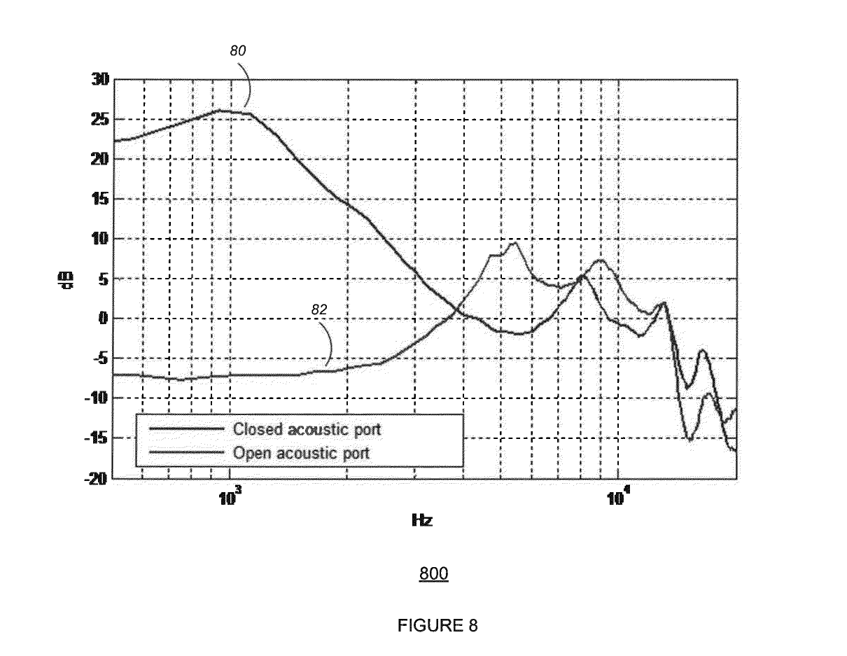

FIG. 8 illustrates an example frequency response caused by an acoustic pressure change of the touch sensor of FIG. 7.

### DESCRIPTION

FIG. 2 shows an example touch sensor 200. A loudspeaker 22 has a front acoustic load 24. Typically the loudspeaker is in an enclosure having a main aperture or port 26 through which most of the acoustic energy radiates from the loudspeaker 22. A detector 28 may be connected to the input of the loudspeaker 22. The detector 28 may output a user command 32. The loudspeaker 22 may be driven by an amplifier 20, which may be a class D audio amplifier. The output of the amplifier 20 may be connected to an input of the detector 28. In operation an audio signal on audio input 30 is amplified by amplifier 20 which drives the loudspeaker 22. Loudspeaker 22 radiates most of the acoustic energy through the acoustic port 26. When the acoustic port 26 is closed, for example by a user blocking the port with their finger, there may be a change in the acoustical load 24 of the loudspeaker that is reflected in its electrical impedance. An acoustic load may be anything that prevents the loudspeaker from moving freely. The smaller the enclosure, the larger the acoustic load. Partially or fully blocking the acoustic port 26 while the loudspeaker is being driven may result in an increase of the front acoustic load resulting in a shift of the resonance frequency to a higher frequency. This shift may be measured by measuring the current flowing through the loudspeaker coil and the voltage across the loudspeaker terminals to determine the change in impedance. If the measured impedance differs by more than a predetermined amount, for example with respect to a reference impedance, the detector 28 may output a user input signal 32 which indicates that there has been a user input command, corresponding for example to the pressing of a button. The detection of the impedance change may be for example by the comparison of one or more samples of the measured impedance with a predetermined reference value, or it may be a measurement of the rate of change of the measured impedance compared to a pre-determined rate of change. The detector 28 as shown is arranged in series with the audio signal path to measure a current flow. The touch sensor 200 may be implemented for example in a mobile phone or other mobile device. The impedance measurement and amplifier may use known voltage and current measurement circuits for example as implemented in the NXP TFA9887UK integrated circuit audio speaker driver. The interpretation of the impedance measurements and the generation of a user signal based on that interpretation may be implemented in hardware, software, or a combination of hardware and software. When integrated into a mobile device, for example a mobile phone, the user input signal may be coupled to a further processor which may interpret the signal as a user command. This user command may be for example to wake-up the mobile phone from a standby mode of operation, go to a home screen, or some other operation.

The acoustic port may consist of one or more apertures or may be a grille.

FIG. 3 shows an example touch sensor 300. A loudspeaker 22 has an acoustic load 24. Typically the loudspeaker is in an enclosure having a main aperture or port 26 through which most of the acoustic energy radiates from the loudspeaker 22. A detector 28 may be connected to the input of the loudspeaker 22. The detector 28 may output a user command or signal 32. The loudspeaker 22 may be driven by an amplifier 20, which may be a class D audio amplifier. A reference signal generator 34 may be connected to a first input of a mixer 36. An audio input 30 may be connected to a second input of the mixer 36. The output of the mixer 36 may be connected to an input of the amplifier 20 which may be a class D audio amplifier. In operation, a mix of audio signal on audio input 30 and the signal generated by reference signal generator 34 may be amplified by amplifier 20 which may drive the loudspeaker 22. Loudspeaker 22 may radiate most of the acoustic energy through the acoustic port 26. When the acoustic port 26 is closed, for example by a user blocking the port with their finger, there may be a change in the acoustical load 24 of the loudspeaker that is reflected in its electrical impedance. Partially or fully blocking the acoustic port 26 while the loudspeaker is being driven may result in an increase of the front acoustic impedance resulting in a shift of the resonance frequency to a higher frequency. This shift may be measured by measuring the current flowing in the loudspeaker coil and the voltage across the loudspeaker terminals to determine the change in impedance. If the measured impedance differs by more than a predetermined amount, for example with respect to a reference impedance, the detector may output a user input signal 32 which indicates that there has been a user input command, corresponding for example to the pressing of a button. The detection of the difference may be for example by the comparison of the measured impedance with a predetermined reference value, or it may be a measurement of the rate of change of the measured impedance compared to a pre-determined rate of change.

Reference signal generator 34 may continuously generate a signal to drive the loudspeaker when a device using the touch sensor is not generating normal sound output. For example in a mobile phone incorporating the sensor, it may be configured in a silent mode so no normal audio is output. Although the signal generator 34 may generate an audible frequency signal, it is not desirable and so normally a non-audible signal may be generated which has energy at frequencies that change when the acoustic speaker port 26 closes. This may for example be a band limited low frequency signal having a pure tone at a frequency between typically 1 Hz and the resonant frequency of the speaker. The resonant frequency of the speaker may be typically in the range of 300 Hz and 600 Hz.

FIG. 4 shows an example touch sensor 400. A loudspeaker 22 has an acoustic load 24. Typically the loudspeaker is in an enclosure having a main aperture or port 26 through which most of the acoustic energy radiates from the loudspeaker 22. Loudspeaker 22 may be in a speaker enclosure 27. A detector 40 may have a voltage measurement input connected to the input of the loudspeaker 22. The detector 40 may output a user command signal on detector output 32. A current sensor 38 may have a current sense input connected to the coil of the loudspeaker 22 and an output connect to an input of the detector 40. The loudspeaker 22 may be driven by an amplifier 20. The output of the amplifier 20 may be connected to the current sensor 38. A reference signal generator 34 may be connected to a first input of a mixer 36. An audio input 30 may be connected to a second input of the mixer 36. The output of the mixer 36 may be connected to an input of the amplifier 20. In operation, a mix of audio signal on audio input 30 and the signal generated by reference signal generator 34 may be amplified by amplifier 20 which may drive the loudspeaker 22. Loudspeaker 22 may radiate most of the acoustic energy through the acoustic port 26. When the acoustic port 26 is closed, for example by a user blocking the port with their finger, there may be a change in the acoustical load 24 of the loudspeaker that is reflected in its electrical impedance. Partially or fully blocking the acoustic port 26 while the loudspeaker is being driven may result in an increase of the front acoustic impedance resulting in a shift of the resonance frequency to a higher frequency. This shift may be measured by measuring the current flowing in the loudspeaker coil sensed by the current sensor 38, and the voltage across the loudspeaker terminals. The detector 40 may combine the measured current and voltage to determine the loudspeaker impedance. If the measured impedance differs by more than a predetermined amount, for example with respect to a reference impedance, the detector may output a user input signal on detector output 32 to indicate that there has been a user input command, corresponding for example to the pressing of a button. The detection of the difference may be for example by the comparison of the measured impedance with a predetermined reference value, or it may be a measurement of the rate of change of the measured impedance compared to a pre-determined rate of change.

FIG. 5 shows an example touch sensor 500. A loudspeaker 22 has an acoustic load 24. The loudspeaker 22 may be in an enclosure 27 having a main aperture or port 26 through which most of the acoustic energy radiates from the loudspeaker 22. A detector 50 may have a voltage measurement input connected to the input of the loudspeaker 22. The detector 50 may output a user command signal on detector output 32. A current sensor 38 may have a current sense input connected to the coil of the loudspeaker 22 and an output connect to an input of the detector 50. The detector 50 may include a reference impedance module 54, an instantaneous impedance module 56 and a comparison module 52. The voltage and current measurement inputs may be connected to reference impedance module 54 and instantaneous impedance module 56. The outputs of reference impedance module 54 and instantaneous impedance module 56 may be connected to comparison module 52. The output of comparison module 52 may be connected to detector output 32. The loudspeaker 22 may be driven by an amplifier 20. The output of the amplifier 20 may be connected to the current sensor 38. A reference signal generator 34 may be connected to a first input of a mixer 36. An audio input 30 may be connected to a second input of the mixer 36. The output of the mixer 36 may be connected to an input of the amplifier 20. In operation, a mix of audio signal on audio input 30 and the signal generated by reference signal generator 34 may be amplified by amplifier 20. Loudspeaker 22 may radiate most of the acoustic energy through the acoustic port 26. When the acoustic port 26 is closed, for example by a user blocking the part with their finger, there may be a change in the acoustical load 24 of the loudspeaker that is reflected in its electrical impedance. Partially or fully blocking the acoustic port 26 while the loudspeaker is being driven may result in an increase of the front acoustic impedance resulting in a shift of the resonance frequency to a higher frequency.

This shift may be measured by measuring the current flowing in the loudspeaker coil sensed by the current sensor 38, and the voltage across the loudspeaker terminals.

Reference impedance module 54 may calculate long term impedance using a slow time constant, i.e. a long refresh time period. This refresh time period may be 1 second or higher. Reference impedance module 54 may determine reference impedance from a number of samples taken during the refresh time period to account for impedance changes not caused by closing or sealing the speaker acoustic port. For example, the reference impedance module may update the reference impedance every second based on impedance measurements calculated during the preceding one second.

Instantaneous impedance module 56 may calculate the loudspeaker impedance with a time constant sufficiently fast to provide the user input signal within an acceptable time delay. This may be a few milliseconds. Instantaneous impedance module 56 may calculate the impedance based on one or more impedance measurements.

The comparator 52 may compare the instantaneous and long term or reference impedances and activate the user input when the difference exceeds a predefined threshold. The comparison may be done in the time domain or in the frequency domain. A single frequency or multiple frequency points may be used depending on the audio signal type. The detector 50 may detect a partial or full sealing of the acoustic port 26 by comparing relative changes of the electrical impedance of the speaker 22. Detector 50 may be implemented in hardware, software or a combination of hardware and software. For example, the detector 50 may be implemented in firmware running on a digital signal processor such as implemented in the NXP TFA9887UK audio driver integrated circuit.

Adapting the reference impedance value may give an improved accuracy of detection since speaker electrical impedance changes may be caused by other factors which may include
A broken or leaky speaker enclosure. This can potentially impact the electrical impedance in the entire frequency range.
speaker manufacturing tolerances (typically up to 10% spread on DC resistance and 20% spread on the resonant frequency)
Speaker temperature. It affects the speaker DC resistance in the following way:

Re(T)=Re(T0)*(1+α(T−T0))

Where
Re(T) is he resistance value at temperature T
T is the current temperature
T0 is the reference temperature (typically 25 degrees Centigrade)
α is the temperature coefficient (in K⁻¹)

In a typical receiver speaker in which Re(T0)=25 Centigrade and α=3.7 e⁻³ K⁻¹, a temperature difference of 10 Centigrade results in a DC resistance increase of 1 Ohm, which is in the same order of magnitude as the differences observed when closing the speaker port. Using an adapted reference impedance therefore mitigates the influence of the above-mentioned effects, so that when a user closes the aperture it may be more reliably detected. The detector user input 32 may be arranged to provide a boolean output indicating a closed or open aperture. Alternatively or in addition the detector user input 32 may provide an indication of the relative difference between the reference measurement and instantaneous measurement. This may be used for example to give an indication of the force used by the user since the harder the finger is pressed against the port, the better the sealing and the larger the difference between the instantaneous and reference measurements.

FIG. 6 shows a graph 600 of impedance plotted on the y-axis against frequency plotted on the x-axis to illustrate the effect of closing the acoustic aperture on a typical receiver speaker which may be used in a touch sensor 500. When the aperture is open the receiver speaker impedance varies according to line 60 with a peak at around 300 Hz. When the aperture 26 is closed or sealed, the impedance profile changes according to line 62 and the peak shifts to around 2 KHz.

FIG. 7 shows an example touch sensor 700. A loudspeaker 22 has an acoustic load 24. Typically the loudspeaker is in an enclosure having a main aperture or port 26 through which most of the acoustic energy radiates from the loudspeaker 22. Loudspeaker 22 may be in a speaker enclosure 27. A microphone 70 may be located in the acoustic load 24. The microphone 70 may be coupled to detector circuit 72. The detector circuit 72 may output a user command signal on detector circuit output 74. A reference signal generator 34 may be connected to a first input of a mixer 36. An audio input 30 may be connected to a second input of the mixer 36. The output of the mixer 36 may be connected to an input of the amplifier 20. In operation, a mix of audio signal on audio input 30 and the signal generated by reference signal generator 34 may be amplified by amplifier 20 which may drive the loudspeaker 22. Loudspeaker 22 may radiate most of the acoustic energy through the acoustic port 26. When the acoustic port 26 is fully or partially closed, for example by a user blocking the port with their finger, the acoustic coupling between the loudspeaker 22 and microphone 70 may increase result in a corresponding sound pressure level increase which will be detected by the microphone 70. This may result in an increased electrical signal from the microphone 70 which may be detected by the detector circuit 72. The detector circuit may output a user input signal 74 when the microphone signal amplitude exceeds a predefined threshold for a certain frequency or frequencies. The microphone 70 and detector circuit 72 may form a detector.

Alternatively a dynamic threshold may be used to account for acoustic path changes differences that are not due to an occlusion of the acoustic port, for example a leaky speaker enclosure 27, or if the phone is placed against the ear resulting in a gradual change in acoustic load is observed. In this case, the user input may be triggered when the instantaneous level exceeds the reference level by more than a predefined threshold, similar to the embodiment of FIG. 5.

FIG. 8 illustrates an example frequency response 800 of the touch sensor of FIG. 7. The y axis is the relative level in decibels of the microphone 70. The x axis is the frequency on a logarithmic scale up to 20 KHz. The graph shows a first frequency response line 80 of microphone 70 when the acoustic port 26 is open. A second line 82 shows a second frequency response line 82 of microphone 70 when the acoustic port 26 is closed. There may be a difference between the frequency response of the microphone 70 when the acoustic port 26 is open compared to when the acoustic port 26 is closed. For example at frequencies of less than 2 kHz, the microphone input level may be up to 30 dB higher when the acoustic port 26 is closed than when the acoustic port 26 is open. By detecting the difference the touch sensor may detect when a user has closed the acoustic port 26. The skilled person will appreciate that partially closing the acoustic port 26 may also result in a detectable difference in the acoustic load. Embodiments of the touch sensors described herein may be incorporated into mobile devices such as mobile phones, tablets, notebooks. The skilled person will appreciate that devices having multiple speakers may have multiple embodiments of the touch sensor so that multiple hardware buttons could potentially be replaced.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A touch sensor for a mobile device, the touch sensor comprising:
an acoustic port,
a loudspeaker operable to output audio through the acoustic port, and
a detector coupled to the loudspeaker; wherein
the detector is operable to detect a change in the acoustic load of the loudspeaker and the touch sensor is operable to generate a user input signal in response to the acoustic port being at least partially sealed.

2. The touch sensor of claim 1 wherein the detector comprises:
a microphone acoustically coupled to the loudspeaker, and
a detection circuit coupled to the microphone; and wherein the detector is operable to detect a change in the acoustic load by detecting a change in sound pressure.

3. The touch sensor of claim 1 wherein the detector is electrically coupled to the input of the loudspeaker and wherein the detector is operable to detect a change in the acoustic load by detecting a change in the loudspeaker electrical impedance.

4. The touch sensor of claim 1 further comprising a reference signal generator coupled to the loudspeaker.

5. The touch sensor of claim 4 wherein the reference signal generator is configured to generate a non-audible signal.

6. The touch sensor of claim 4 wherein the reference signal generator is configured to generate a band-limited low frequency signal.

7. The touch sensor of claim 4 further comprising a mixer having a first input coupled to an audio input, a second input coupled to the reference signal generator and an output coupled to the loudspeaker.

8. The touch sensor of claim 3 wherein the detector comprises:
a current sensor coupled to the loudspeaker input, and
a controller coupled to the loudspeaker input and the output of the current sensor, wherein the controller comprises a voltage detector and is operable to generate the user input signal from a detected change in at least one of the voltage and current.

9. The touch sensor of any of claim 1 wherein the detector comprises:
a comparator configured to compare a reference value with an instantaneous value and to output a user input determined by the comparison.

10. The touch sensor of claim 9 wherein the detector further comprises:
a reference value detector having an input coupled to the loudspeaker and an output coupled to the first input of a comparator,
an instantaneous value detector having an input coupled to the loudspeaker and an output coupled to a second input of the comparator; wherein
the reference value detector is operable to generate the reference value from a plurality of detected values detected over a reference time period, and the instantaneous value detector is operable to generate the instantaneous value from at least one detected value detected during an instantaneous time period, wherein the reference time period is longer than the instantaneous time period.

11. A mobile device comprising the touch sensor of claim 1.

12. A mobile phone comprising the touch sensor of claim 1 wherein the loudspeaker is one of a receiver speaker and a hands-free speaker.

13. A method for detecting a user input to a mobile device, the mobile device comprising an acoustic port, and a loudspeaker arranged to output audio through the acoustic port, the method comprising:
in response to the acoustic port being at least partially sealed detecting a change in the acoustic load of the loudspeaker, and generating a user input signal.

14. The method of claim 13 wherein the step of detecting a change in the acoustic load of the loudspeaker comprises detecting a change in the electrical impedance of the loudspeaker.

15. The method of claim 13 wherein the step of detecting a change in the acoustic load of the loudspeaker comprises detecting a change in the sound pressure level.
